(19) United States
(12) Patent Application Publication
(10) Pub. No.: US 2022/0243427 A1
(43) Pub. Date: Aug. 4, 2022

(54) WORK MACHINE

(71) Applicant: KOMATSU LTD., Minato-ku, Tokyo (JP)

(72) Inventors: Satoru IDE, Minato-ku, Tokyo (JP); Harunobu USHIJIMA, Minato-ku, Tokyo (JP)

(73) Assignee: KOMATSU LTD., Minato-ku, Tokyo (JP)

(21) Appl. No.: 17/622,356

(22) PCT Filed: Aug. 3, 2020
(86) PCT No.: PCT/JP2020/029680

§ 371 Date: Dec. 23, 2021

(30) Foreign Application Priority Data
Aug. 9, 2019 (JP) 2019-147736

(51) Int. Cl. E02F 9/26; E02F 9/24; G06V 20/58

(52) U.S. Cl. CPC E02F 9/261; E02F 9/123; G06V 20/58; E02F 9/24

(57) ABSTRACT

A set area is appropriately set around a work machine. A hydraulic excavator includes a surroundings monitoring apparatus that detects whether or not an object to be recognized is present within a set area set around the hydraulic excavator, a sensor that detects change in position of a traveling unit with respect to a revolving unit, and a controller that controls the hydraulic excavator. The controller sets the set area in accordance with change in position of the traveling unit with respect to the revolving unit detected by the sensor.

### TECHNICAL FIELD

The present disclosure relates to a work machine.

### BACKGROUND ART

An intruding moving object detector that senses an intruding moving object that intrudes into a work area of an earthmoving machine based on a camera image and gives an operator information on a distance of intrusion or probability of the object as a human and a warning signal has conventionally been proposed (see, for example, Japanese Patent Laying-Open No. 10-72851 (PTL 1)).

### CITATION LIST

### Patent Literature

PTL 1: Japanese Patent Laying-Open No. 10-72851

### SUMMARY OF INVENTION

### Technical Problem

A work machine configured to detect whether or not an object to be recognized such as a human is present within a prescribed set area set therearound gives a warning or restricts operations thereof when the object to be recognized is present within the set area. In order to minimize issuance of a warning and restriction of operations of the work machine, appropriate setting of the set area is desired.

The present disclosure provides a work machine capable of appropriately setting a set area therearound.

### Solution to Problem

According to the present disclosure, a work machine including a traveling unit and a revolving unit revolvable with respect to the traveling unit is provided. The work machine includes a surroundings monitoring apparatus that detects whether or not an object to be recognized is present within a set area set around the work machine, a sensor that detects change in position of the traveling unit with respect to the revolving unit, and a controller that controls the work machine. The controller sets the set area in accordance with change in position of the traveling unit with respect to the revolving unit detected by the sensor.

### Advantageous Effects of Invention

According to the present disclosure, a set area can appropriately be set around a work machine.

### BRIEF DESCRIPTION OF DRAWINGS

FIG. 1 is a diagram of appearance of a hydraulic excavator based on an embodiment.

FIG. 2 is a diagram showing overview of a system configuration of the hydraulic excavator based on the embodiment.

FIG. 3 is a schematic diagram for illustrating a set area set around the hydraulic excavator.

FIG. 4 is a schematic diagram for illustrating a first boundary and a second boundary set around the hydraulic excavator.

FIG. 5 is a schematic diagram for illustrating the set area when a revolving unit revolves with respect to a traveling unit.

FIG. 6 is a schematic diagram for illustrating the set area when the revolving unit further revolves with respect to the traveling unit.

FIG. 7 is a schematic diagram of a control system of the hydraulic excavator.

### DESCRIPTION OF EMBODIMENTS

An embodiment will be described hereinafter with reference to the drawings. In the description below, the same elements have the same reference characters allotted and their labels and functions are also the same. Therefore, detailed description thereof will not be repeated.

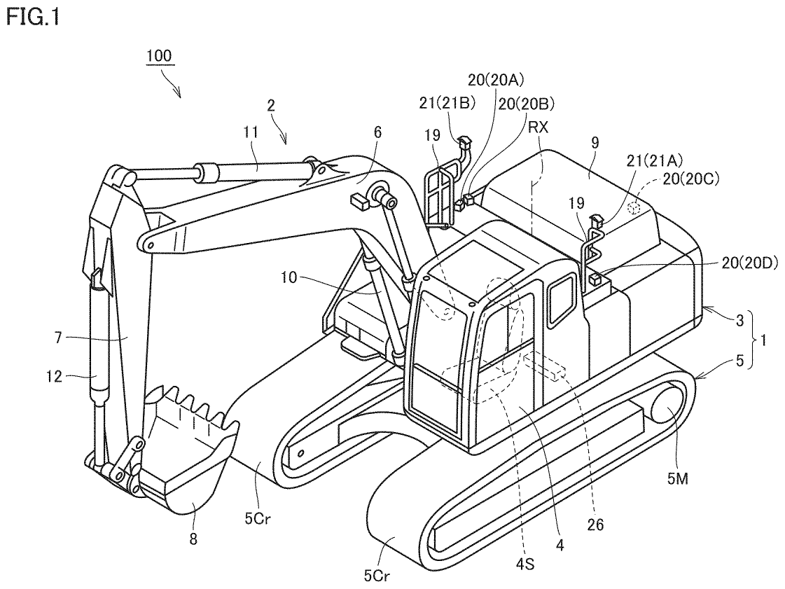

FIG. 1 is a diagram of appearance of a hydraulic excavator 100 based on an embodiment. As shown in FIG. 1, in the present example, hydraulic excavator 100 will mainly be described by way of example as a work machine.

Hydraulic excavator 100 includes a main body 1 and a hydraulically operated work implement 2. Main body 1 includes a revolving unit 3 and a traveling unit 5.

Traveling unit 5 includes a pair of crawler belts 5Cr and a travel motor 5M. Hydraulic excavator 100 can travel as crawler belts 5Cr rotate. Travel motor 5M is provided as a drive source for traveling unit 5. Travel motor 5M is a hydraulically operated hydraulic motor. Traveling unit 5 may include wheels (tires). In operation of hydraulic excavator 100, traveling unit 5 or more specifically crawler belts 5Cr is/are placed on a reference plane such as the ground.

Revolving unit 3 is arranged on traveling unit 5 and supported by traveling unit 5. Revolving unit 3 is mounted on traveling unit 5 as being revolvable with respect to traveling unit 5, around an axis of revolution RX. Revolving unit 3 includes a cab 4. A driver (operator) of hydraulic excavator 100 rides on cab 4 and steers hydraulic excavator 100. Cab 4 is provided with an operator's seat 4S where an operator sits. The operator can operate hydraulic excavator 100 in cab 4. In cab 4, the operator can operate work implement 2, can perform an operation to revolve revolving unit 3 with respect to traveling unit 5, and can perform an operation to move hydraulic excavator 100 by means of traveling unit 5.

Revolving unit 3 includes an engine compartment 9 accommodating an engine and a counterweight provided in a rear portion of revolving unit 3. In engine compartment 9, an engine 31 and a hydraulic pump 33 which will be described later are arranged.

In revolving unit 3, a handrail 19 is provided in front of engine compartment 9. An antenna 21 is provided in handrail 19. Antenna 21 is, for example, an antenna for global navigation satellite systems (GNSS). Antenna 21 includes a first antenna 21A and a second antenna 21B provided in revolving unit 3 as being distant from each other in a direction of a width of a vehicle.

Work implement 2 is supported by revolving unit 3. Work implement 2 includes a boom 6, an arm 7, and a bucket 8. Boom 6 is pivotably coupled to revolving unit 3. Arm 7 is pivotably coupled to a tip end of boom 6. Bucket 8 is pivotably coupled to a tip end of arm 7. Each of arm 7 and bucket 8 is a movable member that is movable on a tip end side of boom 6. Bucket 8 includes a plurality of blades. Bucket 8 does not have to include a blade. The tip end of bucket 8 may be formed from a steel plate in a straight shape.

In the present embodiment, positional relation among components of hydraulic excavator 100 will be described with work implement 2 being defined as the reference.

Boom 6 of work implement 2 pivots with respect to revolving unit 3, around a boom pin provided at the base end of boom 6. Movement of a specific portion of boom 6 which pivots with respect to revolving unit 3, for example, the tip end of boom 6, leaves a trace in an arc shape, and a plane including the arc is specified. When hydraulic excavator 100 is planarly viewed, the plane is represented as a straight line. A direction of extension of this straight line is defined as a fore/aft direction of main body 1 of hydraulic excavator 100 or revolving unit 3, and it is hereinafter also simply referred to as the fore/aft direction. A lateral direction (a direction of a vehicle width) of main body 1 of hydraulic excavator 100 or a lateral direction of revolving unit 3 is orthogonal to the fore/aft direction in a plan view, and it is hereinafter also simply referred to as the lateral direction. An upward/downward direction of the vehicular main body or an upward/downward direction of revolving unit 3 refers to a direction orthogonal to the plane defined by the fore/aft direction and the lateral direction, and it is also simply referred to as the upward/downward direction below.

A side where work implement 2 protrudes from main body 1 of hydraulic excavator 100 in the fore/aft direction is the fore direction and a direction opposite to the fore direction is the aft direction. A right side and a left side of the lateral direction when one faces front are the right direction and the left direction, respectively. A side in the upward/downward direction where the ground is located is defined as a lower side and a side where the sky is located is defined as an upper side.

The fore/aft direction refers to a fore/aft direction of an operator who sits at operator's seat 4S in cab 4. A direction in which the operator sitting at operator's seat 4S faces is defined as the fore direction and a direction behind the operator who sits at operator's seat 4S is defined as the aft direction. The lateral direction refers to a lateral direction of the operator who sits at operator's seat 4S. A right side and a left side at the time when the operator sitting at operator's seat 4S faces front are defined as the right direction and the left direction, respectively. The upward/downward direction refers to the upward/downward direction of the operator who sits at operator's seat 4S. A foot side of the operator who sits at operator's seat 4S is referred to as the lower side and a head side is referred to as the upper side.

Work implement 2 includes a boom cylinder 10, an arm cylinder 11, and a bucket cylinder 12. Boom cylinder 10 drives boom 6. Arm cylinder 11 drives arm 7. Bucket cylinder 12 drives bucket 8. Each of boom cylinder 10, arm cylinder 11, and bucket cylinder 12 is implemented by a hydraulic cylinder driven with hydraulic oil.

Hydraulic excavator 100 includes a camera 20. Camera 20 is an image pick-up apparatus that picks up an image of surroundings of hydraulic excavator 100 and obtains an image of the surroundings of hydraulic excavator 100. Camera 20 is configured to obtain current topography around hydraulic excavator 100 and to recognize presence of an obstacle around hydraulic excavator 100.

Camera 20 includes a front right camera 20A, a right side camera 20B, a rear camera 20C, and a left side camera 20D. Front right camera 20A and right side camera 20B are arranged in a right edge on an upper surface of revolving unit 3. Front right camera 20A is arranged in front of right side camera 20B. Front right camera 20A and right side camera 20B are arranged as being aligned in the fore/aft direction around a central portion of revolving unit 3 in the fore/aft direction.

Rear camera 20C is arranged at a rear end of revolving unit 3 in the fore/aft direction and arranged in a central portion of revolving unit 3 in the lateral direction. The counterweight for keeping balance of a vehicular body in mining or the like is provided at the rear end of revolving unit 3. Rear camera 20C is arranged on an upper surface of the counterweight. Left side camera 20D is arranged in a left edge on the upper surface of revolving unit 3. Left side camera 20D is arranged around the central portion of revolving unit 3 in the fore/aft direction.

A controller 26 is mounted on hydraulic excavator 100. Controller 26 controls operations of hydraulic excavator 100. Details of controller 26 will be described later.

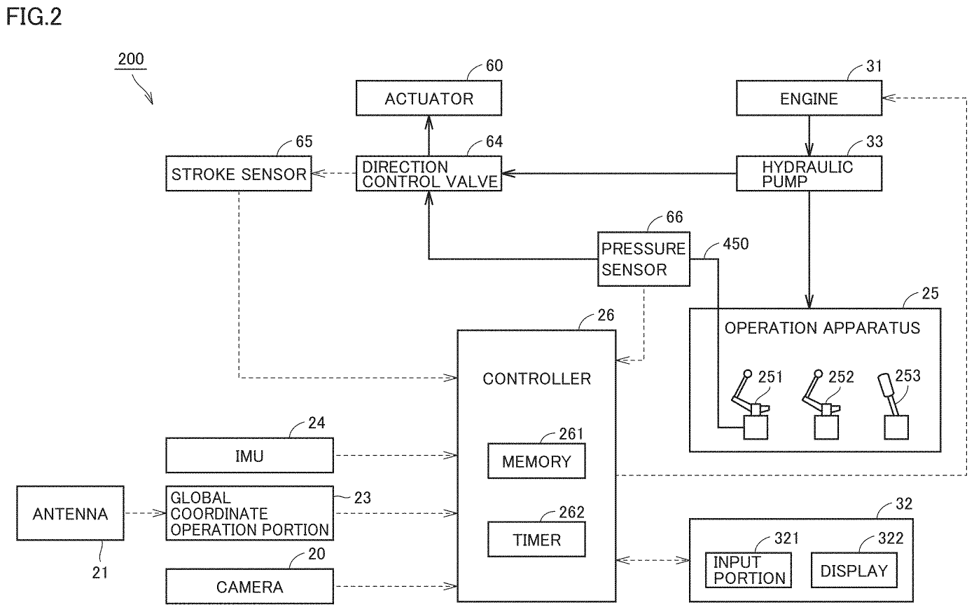

FIG. 2 is a block diagram showing a system configuration of hydraulic excavator 100 based on the embodiment. A solid line in FIG. 2 shows a hydraulic circuit. A dashed line in FIG. 2 shows an electric circuit. FIG. 2 shows only a part of the electric circuit included in hydraulic excavator 100 in the embodiment. As shown in FIG. 2, a control system 200 is mounted on hydraulic excavator 100.

Control system 200 includes camera 20, antenna 21, a global coordinate operation portion 23, an inertial measurement unit (IMU) 24, an operation apparatus 25, controller 26, a direction control valve 64, a pressure sensor 66, and a man-machine interface portion 32.

Controller 26 controls operations of entire hydraulic excavator 100, and it is implemented by a computing device such as a central processing unit (CPU), a memory 261, and a timer 262. Memory 261 is a non-volatile memory and provided as an area for storing necessary data. Memory 261 stores a program for controlling various operations by hydraulic excavator 100. Controller 26 performs various types of processing for controlling operations by hydraulic excavator 100 based on the program stored in memory 261. Timer 262 counts prescribed time.

An image of surroundings of hydraulic excavator 100 obtained by camera 20 shown in FIG. 1 is provided to controller 26. Controller 26 generates an image of the surroundings of hydraulic excavator 100 from the image picked up by camera 20. The image of the surroundings of hydraulic excavator 100 includes a single image generated from an image picked up by any one of front right camera 20A, right side camera 20B, rear camera 20C, and left side camera 20D. The image of the surroundings of hydraulic excavator 100 includes a bird's-eye image generated by combining a plurality of images picked up by front right camera 20A, right side camera 20B, rear camera 20C, and left side camera 20D.

Antenna 21 provides a signal in accordance with received radio waves (GNSS radio waves) to global coordinate operation portion 23. Global coordinate operation portion 23 detects a position of installation of antenna 21 on a global coordinate system. The global coordinate system is a three-dimensional coordinate system based on a reference position set in a work area. The reference position may be a position of a tip end of a reference marker set in the work area.

IMU 24 is provided in revolving unit 3. In the present example, IMU 24 is arranged in a lower portion of cab 4. In revolving unit 3, a highly rigid frame is arranged in the lower portion of cab 4. IMU 24 is arranged on that frame. IMU 24 may be arranged lateral to (on the right or left of) axis of revolution RX of revolving unit 3. IMU 24 measures an acceleration of revolving unit 3 in the fore/aft direction, the lateral direction, and the upward/downward direction and an angular velocity of revolving unit 3 around the fore/aft direction, the lateral direction, and the upward/downward direction.

Operation apparatus 25 is arranged in cab 4. The operator operates operation apparatus 25. Operation apparatus 25 accepts an operation by the operator to travel hydraulic excavator 100 (traveling unit 5). Operation apparatus 25 accepts an operation by the operator for driving work implement 2. Operation apparatus 25 provides an operation signal in accordance with an operation by the operator. In the present example, operation apparatus 25 is an operation apparatus of a pilot hydraulic type.

Control system 200 is configured such that hydraulic oil delivered from hydraulic pump 33 as a result of drive of hydraulic pump 33 by engine 31 is supplied to various hydraulic actuators 60 through direction control valve 64 in correspondence with an operation onto operation apparatus 25 by the operator. As application and release of a hydraulic pressure to and from hydraulic actuator 60 is controlled, an operation of work implement 2, revolution of revolving unit 3, and a traveling operation of traveling unit 5 are controlled. Hydraulic actuator 60 includes boom cylinder 10, arm cylinder 11, bucket cylinder 12, and travel motor 5M shown in FIG. 1 and a revolution motor.

Engine 31 is, for example, a diesel engine. Controller 26 controls operations of engine 31. As controller 26 controls an amount of fuel injected into engine 31, output from engine 31 is controlled. Engine 31 includes a driveshaft for coupling to hydraulic pump 33.

Hydraulic pump 33 is coupled to the driveshaft of engine 31. As rotational driving force of engine 31 is transmitted to hydraulic pump 33, hydraulic pump 33 is driven. Hydraulic pump 33 is a variable displacement hydraulic pump which includes a swash plate and varies a discharge volume with variation in tilting angle of the swash plate. Hydraulic pump 33 supplies hydraulic oil used for drive of work implement 2, travel of traveling unit 5, and revolution of revolving unit 3. Hydraulic oil delivered from hydraulic pump 33 is reduced in pressure to a certain pressure through a pressure reduction valve and supplied to direction control valve 64.

Direction control valve 64 is a spool valve that switches a direction of flow of hydraulic oil by movement of a rod-like spool. Direction control valve 64 includes a spool that adjusts an amount of supply of hydraulic oil for each of boom cylinder 10, arm cylinder 11, bucket cylinder 12, travel motor 5M, and the revolution motor. As the spool axially moves, an amount of supply of hydraulic oil to hydraulic actuator 60 is regulated. Direction control valve 64 is provided with a spool stroke sensor 65 that detects a stroke of the spool (spool stroke). A detection signal from spool stroke sensor 65 is provided to controller 26.

In the present example, oil supplied to hydraulic actuator 60 in order to activate hydraulic actuator 60 is referred to as hydraulic oil. Oil supplied to direction control valve 64 for activating the spool of direction control valve 64 is referred to as pilot oil. A pressure of the pilot oil is also referred to as a pilot oil pressure.

Hydraulic oil and pilot oil may be delivered from the same hydraulic pump. For example, a pressure of some of hydraulic oil delivered from hydraulic pump 33 may be reduced by a pressure reduction valve and hydraulic oil, a pressure of which has been reduced, may be used as pilot oil. Separately from hydraulic pump 33 that delivers hydraulic oil (a main hydraulic pump), a hydraulic pump that delivers pilot oil (a pilot hydraulic pump) may be provided.

Operation apparatus 25 includes a first travel control lever 251, a second travel control lever 252, and a work implement lever 253. First travel control lever 251 and second travel control lever 252 are arranged, for example, in front of operator's seat 4S. Work implement lever 253 is arranged, for example, laterally to operator's seat 4S.

A pair of travel control levers 251 and 252 is members operated by an operator for controlling travel of hydraulic excavator 100 (traveling unit 5). Work implement lever 253 is a member operated by the operator for controlling operations by work implement 2, that is, boom 6, arm 7, and bucket 8 and revolution of revolving unit 3.

Pilot oil delivered from the hydraulic pump, a pressure of which has been reduced by the pressure reduction valve, is supplied to operation apparatus 25. The pilot oil pressure is regulated based on an amount of operation of operation apparatus 25.

Operation apparatus 25 and direction control valve 64 are connected to each other through a pilot oil path 450. Pilot oil is supplied to direction control valve 64 through pilot oil path 450.

Pressure sensor 66 is arranged in pilot oil path 450. Pressure sensor 66 detects a pilot oil pressure. Results of detection by pressure sensor 66 are provided to controller 26.

As first travel control lever 251 is operated, a pilot oil pressure corresponding to an amount of operation is supplied to direction control valve 64. Direction control valve 64 regulates a direction of flow and a flow rate of hydraulic oil supplied to right travel motor 5M. Supply of hydraulic oil to right travel motor 5M is thus controlled to control output from a right traveling apparatus.

As second travel control lever 252 is operated, a pilot oil pressure corresponding to an amount of operation is supplied to direction control valve 64. Direction control valve 64 regulates a direction of flow and a flow rate of hydraulic oil supplied to left travel motor 5M. Supply of hydraulic oil to left travel motor 5M is thus controlled to control output from a left traveling apparatus.

The direction of rotation of right travel motor 5M is switched in accordance with the direction of operation of first travel control lever 251. The direction of rotation of left travel motor 5M is switched in accordance with the direction of operation of second travel control lever 252. Hydraulic excavator 100 can move forward or rearward by rotation of left and right travel motors 5M in the same direction, and hydraulic excavator 100 can make a spin turn by rotation of left and right travel motors 5M in directions reverse to each other.

As set forth above, the operator can control a traveling operation of hydraulic excavator 100 by operating first travel control lever 251 and second travel control lever 252.

As work implement lever 253 is operated, a pilot oil pressure corresponding to such operation contents is supplied to direction control valve 64. A direction of flow and a flow rate of hydraulic oil supplied to boom cylinder 10, arm cylinder 11, bucket cylinder 12, and the revolution motor are thus regulated to control operations by work implement 2 and a revolving operation of revolving unit 3.

Man-machine interface portion 32 includes an input portion 321 and a display (a monitor) 322. In the present example, input portion 321 includes an operation button arranged around display 322. Input portion 321 may include a touch panel. Man-machine interface portion 32 is also referred to as a multi-monitor.

Input portion 321 is operated by an operator. A command signal generated in response to an operation onto input portion 321 is provided to controller 26. Display 322 displays vehicular body information of hydraulic excavator 100. The vehicular body information of hydraulic excavator 100 includes, for example, a work mode of hydraulic excavator 100, an amount of remaining fuel shown by a fuel gauge, a temperature of coolant or a temperature of hydraulic oil shown by a thermometer, and an operating state of an air-conditioner. Display 322 shows an image of surroundings of hydraulic excavator 100 generated by controller 26.

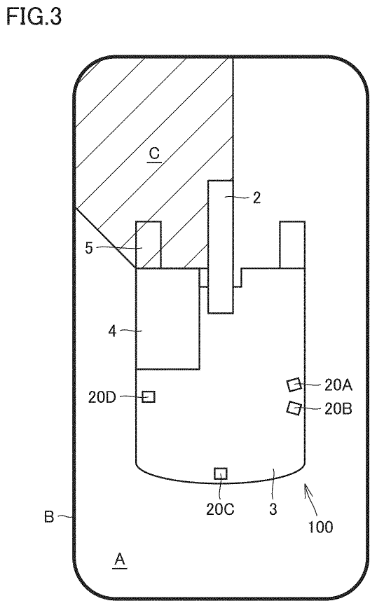

FIG. 3 is a schematic diagram for illustrating a set area A set around hydraulic excavator 100. FIG. 3 shows overview of hydraulic excavator 100 in a plan view. In FIG. 3, the fore/aft direction of revolving unit 3 corresponds to the upward/downward direction in the figure.

As shown in FIG. 3, a boundary line B is set around hydraulic excavator 100. Boundary line B defines a boundary line for detecting presence of an obstacle as an object to be recognized such as a human on an inner side of boundary line B, that is, in the vicinity of hydraulic excavator 100 relative to boundary line B. An area set on the inner side of boundary line B is referred to as set area A. Controller 26 shown in FIG. 2 sets boundary line B around hydraulic excavator 100 and sets the area on the inner side of boundary line B as set area A.

Crawler belt 5Cr shown in FIG. 3 extends in the fore/aft direction of revolving unit 3. When crawler belt 5Cr and revolving unit 3 shown in FIG. 3 are in the same orientation, boundary line B is set to be in a substantially rectangular shape having a long side in the fore/aft direction of revolving unit 3 and a short side in the lateral direction of revolving unit 3. Set area A is set to be in a vertically long substantially quadrangular shape.

A visible area C shown with hatching in FIG. 3 represents an area that is visually recognizable by an operator in cab 4 when the operator faces front. Visible area C is set in front of revolving unit 3. Visible area C corresponds to a blind spot of camera 20, and images picked up by front right camera 20A, right side camera 20B, rear camera 20C, and left side camera 20D do not include visible area C.

Camera 20 obtains an image of surroundings of hydraulic excavator 100 except for visible area C. Controller 26 sets as set area A, an area on the inner side of boundary line B except for visible area C. Camera 20 can obtain an image of the inside of set area A. Controller 26 determines whether or not an obstacle as an object to be recognized such as a human is within an image obtained by camera 20, so that whether or not the object to be recognized is present around hydraulic excavator 100 is detected. Camera 20 and controller 26 implement the surroundings monitoring apparatus in the embodiment.

Controller 26 sets set area A within a range where the surroundings monitoring apparatus is able to recognize an object to be recognized. Controller 26 detects whether or not the object to be recognized such as a human is present within set area A from an image of the inside of set area A obtained by camera 20. Camera 20 is unable to obtain an image of the inside of visible area C, and whether or not an object to be recognized is present within visible area C cannot be detected from the image obtained by camera 20. Therefore, visible area C is excluded from set area A.

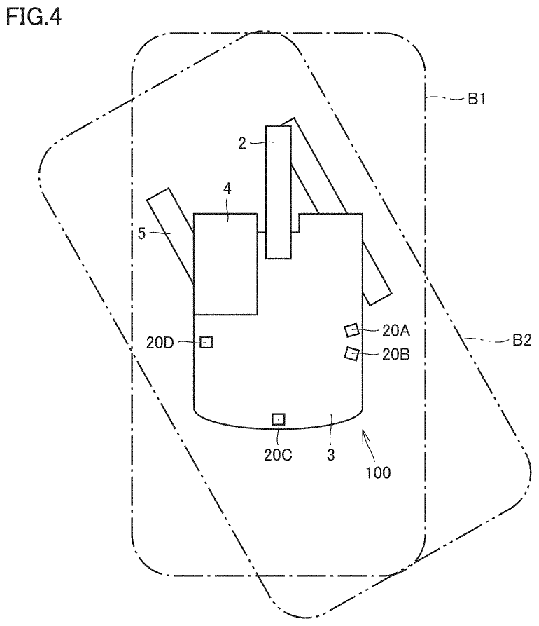

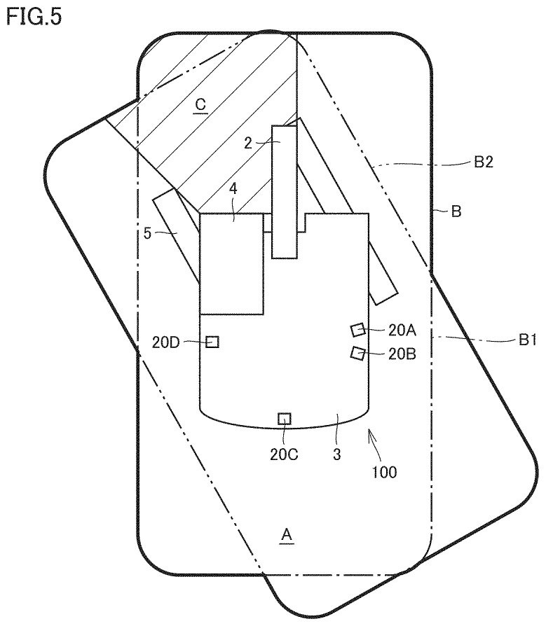

FIG. 4 is a schematic diagram for illustrating a first boundary B1 and a second boundary B2 set around hydraulic excavator 100. FIG. 5 is a schematic diagram for illustrating set area A when revolving unit 3 revolves with respect to traveling unit 5. In hydraulic excavator 100 shown in FIGS. 4 and 5, revolving unit 3 has turned relatively to traveling unit 5 from an attitude shown in FIG. 3. Crawler belt 5Cr extends in a direction inclined with respect to the fore/aft direction of revolving unit 3. At this time, controller 26 sets first boundary B1 around revolving unit 3 and sets second boundary B2 different from first boundary B1 around traveling unit 5. FIGS. 4 and 5 and FIG. 6 which will be described later show first boundary B1 with a chain dotted line and show second boundary B2 with a chain double dotted line.

First boundary B1 is set to be in a substantially rectangular shape having a long side in the fore/aft direction of revolving unit 3 and a short side in the lateral direction of revolving unit 3. Second boundary B2 is set to be in a substantially rectangular shape having a long side in a direction of extension of crawler belt 5Cr. An area on the inner side of first boundary B1 only partially overlaps with an area on the inner side of second boundary B2. The area on the inner side of first boundary B1 and the area on the inner side of second boundary B2 include a portion not overlapping with each other.

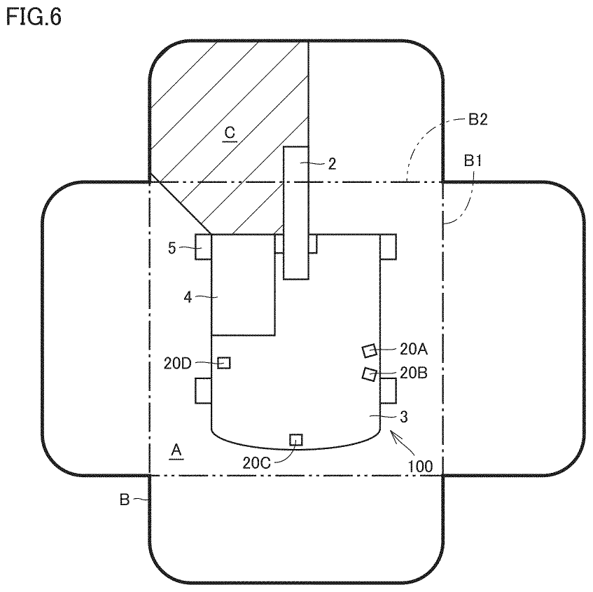

In this case, controller 26 sets as set area A, an area on the inner side of at least any one of first boundary B1 and second boundary B2 except for visible area C. Controller 26 sets as set area A, an area on the inner side of first boundary B1 and on the inner side of second boundary B2, an area on an outer side of first boundary B1 but on the inner side of second boundary B2, and an area on the outer side of second boundary B2 but on the inner side of first boundary B1. FIG. 5 and FIG. 6 which will be described later show boundary line B for defining set area A with a bold solid line.

When hydraulic excavator 100 is in the attitude shown in FIG. 3 and crawler belt 5Cr extends in the fore/aft direction of revolving unit 3, first boundary B1 and second boundary B2 coincide with each other, and first boundary B1 and second boundary B2 are superimposed on boundary line B. First boundary B1 and second boundary B2 coincide with boundary line B shown in FIG. 3.

Revolving unit 3 revolves with respect to traveling unit 5 from the attitude of hydraulic excavator 100 shown in FIG. 3, and in correspondence with this revolution of revolving unit 3, controller 26 has first boundary B1 turned relatively to second boundary B2 as shown in FIG. 4. Controller 26 sets set area A in accordance with change in position of traveling unit 5 with respect to revolving unit 3. More specifically, controller 26 changes set area A as shown in FIG. 5 by changing the position of first boundary B1 with respect to second boundary B2 in correspondence with change in angle of traveling unit 5 with respect to revolving unit 3.

Boundary line B shown in FIG. 5 is different in shape from boundary line B in FIG. 3. Unlike the boundary line in FIG. 3, boundary line B shown in FIG. 5 is not set to be in a substantially quadrangular shape. Boundary line B is set to be in a shape of a vertically long substantially rectangular shape and an obliquely extending substantially rectangular shape as being combined.

FIG. 6 is a schematic diagram for illustrating set area A when revolving unit 3 further revolves with respect to traveling unit 5. In hydraulic excavator 100 shown in FIG. 6, revolving unit 3 has rotated by 90° relatively to traveling unit 5 from the attitude shown in FIG. 3, and the direction of extension of crawler belt 5Cr is orthogonal to the fore/aft direction of revolving unit 3. In hydraulic excavator 100 shown in FIG. 6, an angle of traveling unit 5 with respect to revolving unit 3 is largest. In hydraulic excavator 100 shown in FIG. 6, change in position of traveling unit 5 with respect to revolving unit 3 from the attitude in which crawler belt 5Cr and revolving unit 3 are in the same orientation shown in FIG. 3 is largest.

Controller 26 sets first boundary B1 around revolving unit 3 and sets second boundary B2 different from first boundary B1 around traveling unit 5. First boundary B1 is set to be in a substantially rectangular shape having the long side in the fore/aft direction of revolving unit 3 and the short side in the lateral direction of revolving unit 3. Second boundary B2 is set to be in the substantially rectangular shape having the long side in the direction of extension of crawler belt 5Cr. Second boundary B2 is set to be in the substantially rectangular shape having the long side in the lateral direction of revolving unit 3 and the short side in the fore/aft direction of revolving unit 3.

Controller 26 sets as set area A, the area on the inner side of at least any one of first boundary B1 and second boundary B2 except for visible area C. As shown in FIG. 6, boundary line B is set to be in the shape of the vertically long substantially rectangular shape and a laterally long substantially rectangular shape as being combined. Set area A shown in FIG. 6 is longer in a width direction of revolving unit 3 (lateral direction in the figure) than set area A shown in FIGS. 3 and 5. In arrangement in which the angle of traveling unit 5 with respect to revolving unit 3 is 90° shown in FIG. 6, the length of set area A in the width direction of revolving unit 3 is longest.

Functions and effects of the present embodiment will now be described.

In hydraulic excavator 100 in the embodiment, as shown in FIG. 2, control system 200 includes camera 20, IMU 24, and controller 26. Camera 20 and controller 26 implement the surroundings monitoring apparatus in the embodiment. IMU 24 can measure an angular velocity of revolving unit 3 around the upward/downward direction. IMU 24 performs a function as a sensor in the embodiment that detects an angle of traveling unit 5 with respect to revolving unit 3. Controller 26 sets set area A in accordance with the angle of traveling unit 5 with respect to revolving unit 3 as shown in FIGS. 3 and 5 to 6.

Second boundary B2 is set around traveling unit 5 and first boundary B1 different from second boundary B2 is set around revolving unit 3 revolvable with respect to traveling unit 5. First boundary B1 and second boundary B2 thus define set area A. By combining first boundary B1 and second boundary B2 in conformity with actual positional relation between revolving unit 3 and traveling unit 5 instead of setting a certain set area without depending on an angle of revolution of revolving unit 3 with respect to traveling unit 5, optimal set area A is automatically set. Set area A can thus appropriately be set around hydraulic excavator 100.

By sensing the angle of traveling unit 5 with respect to revolving unit 3 with the sensor, optimal set area A in conformity with the angle can automatically be set. The sensor that detects the angle of revolving unit 3 with respect to traveling unit 5 is not limited to IMU 24. A potentiometer attached to the revolution motor may detect the angle of revolution of revolving unit 3. The angle of revolution of revolving unit 3 may be detected from an image picked up by camera 20 attached to revolving unit 3 or a camera arranged outside hydraulic excavator 100.

As shown in FIGS. 3 and 5 to 6, controller 26 has first boundary B1 turned relatively to second boundary B2 in correspondence with change in angle of traveling unit 5 with respect to revolving unit 3. Controller 26 thus changes set area A by changing the position of first boundary B1 with respect to second boundary B2. By changing set area A in accordance with change in angle of traveling unit 5 with respect to revolving unit 3, optimal set area A in conformity with the angle of revolution can automatically be set.

As shown in FIG. 6, when the angle of traveling unit 5 with respect to revolving unit 3 is 90°, the length of set area A in the width direction of revolving unit 3 is longest. Set area A is set in correspondence with the direction of extension of crawler belt 5Cr when crawler belt 5Cr extends as being orthogonal to the fore/aft direction of revolving unit 3. Set area A can thus appropriately be set around hydraulic excavator 100.

As shown in FIGS. 3 and 5 to 6, controller 26 sets set area A within the range except for visible area C. An image picked up by camera 20 does not include visible area C and presence of an obstacle within visible area C cannot be detected based on the image picked up by camera 20. Set area A is set except for visible area C which is a range where controller 26 is unable to recognize an object to be recognized in the image picked up by camera 20. Controller 26 sets set area A within a range where controller 26 is able to recognize an object to be recognized in the image picked up by camera 20. Set area A can thus appropriately be set around hydraulic excavator 100.

As shown in FIG. 4, second boundary B2 has a longitudinal direction in the direction of extension of crawler belt 5Cr and has a direction of the short side in the direction orthogonal to the direction of extension of crawler belt 5Cr. The direction of extension of crawler belt 5Cr corresponds to a direction of travel of traveling unit 5. Therefore, controller 26 sets the length of second boundary B2 in the direction of travel of traveling unit 5 to be longer than the length of second boundary B2 in the orthogonal direction orthogonal to the direction of travel.

By setting second boundary B2 to be longer in a direction in which traveling unit 5 can travel than in the orthogonal direction orthogonal to the direction of travel, set area A is longer in the direction of travel. By setting set area A in the direction of travel of traveling unit 5 to be longer than set area A in a direction of non-travel in which traveling unit 5 does not travel, presence of an object to be recognized in the direction in which traveling unit 5 is to travel can more reliably be sensed in advance. By thus appropriately setting set area A, contact of traveling unit 5 that is traveling with an obstacle can be avoided.

A traveling speed of traveling unit 5 may be detected by IMU 24 and a ratio between the length in the direction of travel and the length in the orthogonal direction of second boundary B2 may be varied in correspondence with the traveling speed. Control system 200 may be configured to include a rotation number sensor that detects the number of rotations of engine 31 and to vary the ratio between the length in the direction of travel and the length in the orthogonal direction of second boundary B2 in correspondence with the number of rotations of engine 31. With increase in traveling speed of traveling unit 5, the ratio between the length in the direction of travel and the length in the orthogonal direction of second boundary B2 can be increased, for example, stepwise. Since set area A is thus appropriately set, contact of traveling unit 5 that is traveling with an obstacle can reliably be avoided.

In the description of the embodiment above, an example in which hydraulic excavator 100 includes controller 26 and controller 26 mounted on hydraulic excavator 100 controls operations of hydraulic excavator 100 is described. The controller that controls operations of hydraulic excavator 100 does not necessarily have to be mounted on hydraulic excavator 100.

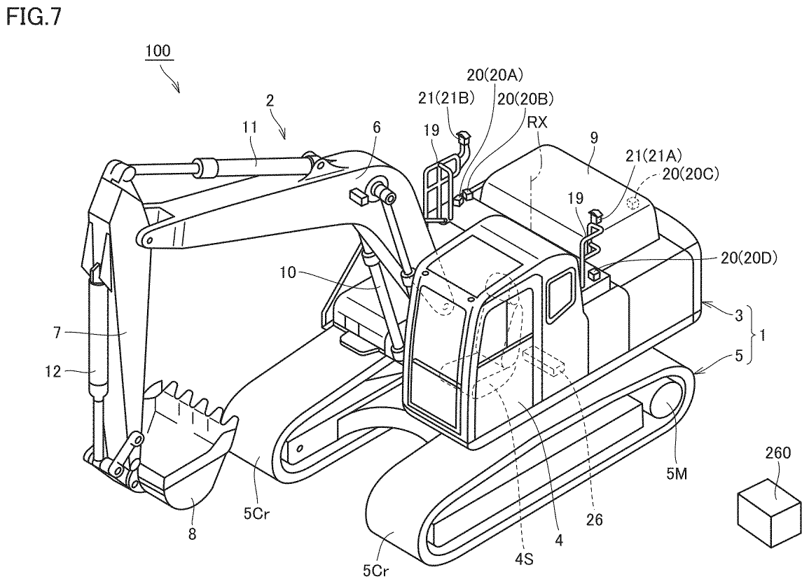

FIG. 7 is a schematic diagram of a control system of hydraulic excavator 100. An external controller 260 provided separately from controller 26 mounted on hydraulic excavator 100 may configure a control system of hydraulic excavator 100. Controller 260 may be arranged at the work site of hydraulic excavator 100 or a remote location distant from the work site of hydraulic excavator 100.

It should be understood that the embodiment disclosed herein is illustrative and non-restrictive in every respect. The scope of the present invention is defined by the terms of the claims rather than the description above and is intended to include any modifications within the scope and meaning equivalent to the terms of the claims.

### REFERENCE SIGNS LIST

1 main body; 2 work implement; 3 revolving unit; 4 cab; 4S operator's seat; 5 traveling unit; 5Cr crawler belt; 5M travel motor; 6 boom; 7 arm; 8 bucket; 9 engine compartment; 10 boom cylinder; 11 arm cylinder; 12 bucket cylinder; 19 handrail; 20 camera; 20A front right camera; 20B right side camera; 20C rear camera; 20D left side camera; 21 antenna; 21A first antenna; 21B second antenna; 23 global coordinate operation portion; 25 operation apparatus; 26, 260 controller; 31 engine; 32 man machine interface portion; 33 hydraulic pump; 60 hydraulic actuator; 64 direction control valve; 65 spool stroke sensor; 66 pressure sensor; 100 hydraulic excavator; 200 control system; 251 first travel control lever; 252 second travel control lever; 253 work implement lever; 261 memory; 262 timer; 321 input portion; 322 display; 450 pilot oil path; A set area; B boundary line; B1 first boundary; B2 second boundary; RX axis of revolution

1. A work machine including a traveling unit and a revolving unit revolvable with respect to the traveling unit, the work machine comprising:
a surroundings monitoring apparatus that detects whether an object to be recognized is present within a set area set around the work machine;
a sensor that detects change in position of the traveling unit with respect to the revolving unit; and
a controller that controls the work machine, wherein
the controller sets the set area in accordance with change in position of the traveling unit with respect to the revolving unit detected by the sensor.

2. The work machine according to claim 1, wherein
the controller changes the set area in correspondence with change in angle of the traveling unit with respect to the revolving unit.

3. The work machine according to claim 2, wherein
when the angle of the traveling unit with respect to the revolving unit is 90°, a length of the set area in a width direction of the revolving unit is longest.

4. The work machine according to claim 1, wherein
the controller sets the set area within a range where the surroundings monitoring apparatus is able to recognize the object to be recognized.

5. The work machine according to claim 1, wherein
the controller sets a boundary around the traveling unit and sets a length of the boundary in a direction of travel of the traveling unit to be longer than a length of the boundary in an orthogonal direction orthogonal to the direction of travel.
